(19) United States
(12) Patent Application Publication
(10) Pub. No.: US 2024/0091912 A1
(43) Pub. Date: Mar. 21, 2024

(54) Sprinkler Cap Removal Tool

(71) Applicant: David M. Fisher, Star, ID (US)

(72) Inventor: David M. Fisher, Star, ID (US)

(21) Appl. No.: 18/471,176

(22) Filed: Sep. 20, 2023

Related U.S. Application Data
(60) Provisional application No. 63/376,321, filed on Sep. 20, 2022.

(51) Int. Cl. B25B 13/50; B05B 15/00; B25B 23/00

(52) U.S. Cl. CPC B25B 13/50; B05B 15/00; B25B 23/0035

(57) ABSTRACT

An improved sprinkler head removal tool for use in removing sprinkler heads from cans positioned in the ground. The sprinkler heads have a series of indentations positioned around the head of the sprinkler. The improved sprinkler head removal tool has a U-shaped head that is configured to span across the head such that the opposing arms or prongs of the U-shape are positioned in opposing depressions. The U-shaped head is connected to a handle, which a user grasps and rotates. The U-shaped head is preferably configured to thread onto the handle of a plastic pipe nipple extractor or other sprinkler head tool.

### CROSS-REFERENCE TO RELATED APPLICATIONS

This application claims the benefit of U.S. Provisional Application No. 62/376,321, filed Sep. 20, 2022, the disclosure and contents of which are incorporated by reference.

### TECHNICAL FIELD

The disclosure generally relates to the field of gear drive sprinkler tools and methods.

Particular embodiments relate to an improved gear drive sprinkler removal tool.

### BACKGROUND

Gear drive sprinklers utilize a gear drive system housed within a body of a sprinkler. The body of a sprinkler is formed typically of a cylinder having a water intake. The drive body of the gear drive system is positioned within the body of the sprinkler. A turbine is positioned at the base of the sprinkler gear drive body. Water flow over the turbine drives a series of gears to cause the sprinkler head to rotate. The gear drive system is retained within the housing by a head. Typically, this head has a series of indentations positioned on the head. The head has the center opening through which the riser extends when water is flowing through the sprinkler.

Gear drive systems can be difficult to maintain or fix. Typically, the gear drive sprinkler is positioned such that the top of the head of the sprinkler is even with the sod or ground around the sprinkler. This positioning is to protect the sprinkler head from potential abuse, hitting the sprinkler with a lawnmower or a person stepping or potentially kicking the sprinkler head. However due to this safety positioning, it is difficult to remove the cap of the sprinkler. Typically to remove the cap of a gear drive sprinkler, a person must dig around the sprinkler head to provide enough room which the person can grasp and rotate the sprinkler cap off of the sprinkler. Accordingly, what is needed is an improved tool for use in removing the cap to allow access to the internal gear drive system.

### SUMMARY

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

What is disclosed is an improved tool for use with a gear drive sprinkler. The improved tool facilities removal of the cap of a gear drive sprinkler. The tool utilizes a U-shaped sprinkler head engagement end. The U-Shaped sprinkler head engagement end has two prongs spaced apart by a connector rod. The connector rod is configured for attachment to a shaft and handle. The U-Shaped head can be fixedly attached to the shaft and handle or can be configured for removable attachment. A series of heads of different widths can be provided. Each width is configured for a different sprinkler cap. The U-Shaped tool and prongs are configured to extend such that the base of the U-shape extends across the sprinkler cap with the arms of the U extending down into opposing depressions of the cap. This configuration allows for access and removable of the cap without the need to excavate the soil, grass or sod around the sprinkler.

A method of using a tool having a U-Shaped head is disclosed herein. The method includes providing a tool having an elongated handle section. The tool has a head having a U-shape. The U-Shape has two arms or prongs extending generally parallel to the direction of the length of the handle. The handle is attached to the U-Shaped section at the cross base. The handle can be threading attached or alternative mechanisms for attachment can be utilized. Alternatively, the U-Shape can be formed with the handle. The device is utilized by positioning each of the ends of the arms of the U-Shaped head into opposing depressions in the cap of a gear drive sprinkler. The handle is then rotated typically clockwise, although some sprinkler heads are reverse threaded, until the cap can be removed, and the internal components of the gear drive sprinkler are lifted out of the housing. The U-shaped head can be provided in a variety of widths and arm lengths configured for gear drive sprinklers of different sizes. The two currently thought preferred sizes for the internal width between the arms of the U are two (2) inches and two and a half (2.5) inches. Either round or square or alternate cross sectional shaped arms can be utilized. Preferably the arms are one and a quarter inches (1¼) in length up to one and a half inches (1½″, with a width of ⅓ of an inch) to the cross piece of the U-shape.

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

### BRIEF DESCRIPTION OF THE FIGURES

FIG. 1 is a perspective view of the prongs of the sprinkler head removal tool positioned within depressions of a sprinkler head adjacent to the sprinkler can.

FIG. 2 is a perspective view of the U-shaped head of the sprinkler head removal tool.

FIG. 3 is a perspective view of an assembled sprinkler head removal tool.

FIG. 4 is a top perspective view of the U-shaped head of the sprinkler head removal tool.

FIG. 5 is a perspective view of the sprinkler head removal tool positioned in the depressions of a sprinkler head, with the sprinkler head positioned in a can.

FIG. 6 is a perspective view of the sprinkler head removal tool and sprinkler hear of FIG. 5.

FIG. 7 is an exploded view of a sprinkler head removal tool.

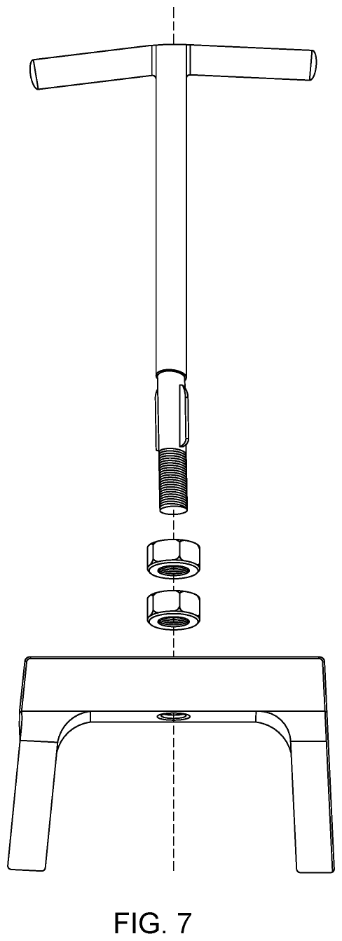

### DETAILED DESCRIPTION OF THE FIGURES

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

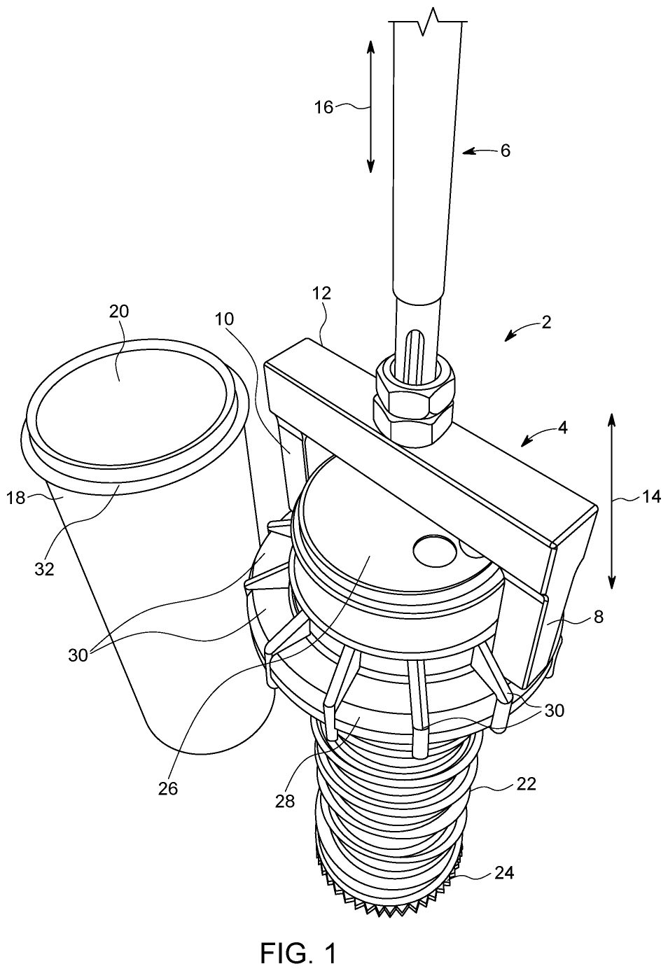

FIG. 1 illustrates the sprinkler tool 2 having a U-Shaped head 7 for an elongated handle 6. The U-Shaped tool has opposing arms 8, 10 that extend from a cross piece 12. Preferably the U-Shaped arms extend from the cross piece in a parallel direction 14 to the lengthwise axis of the handle 16. The base of the U-Shaped head is generally perpendicular to the handle to provide for maximum rotational torque to be transferred from the elongated handle to the U-Shaped head.

FIG. 1 illustrates the tool utilized on a partially disassembled gear drive sprinkler. The cylindrical housing 18 of the sprinkler is shown with forming cavity 20. The cylindrical housing is typically embedded in the ground such that the riser extends out of the housing when water is flowing through the sprinkler body. The internal body 22 of the gear drive sprinkler is positioned within the cylindrical housing 20 of the gear drive sprinkler. The turbine 24 of the gear drive sprinkler is illustrated at the base of the internal components of the gear drive sprinkler. The pop-up head 26 is illustrated in the opening of the cap 28 of the sprinkler. Depressions 30 extend circumferentially around the opening of the head and are formed by radial walls 30. The arms or prongs 8, 10 of the U-Shaped head are configured to fit within the depressions of the cap. The arms are formed to transfer rotational torque from rotation of the handle to the walls of the depressions. This transfer of torque causes the head to be threaded onto or off of the external threads 32 of the cylindrical housing. In a preferred embodiment, as depicted, the elongated handle 6 is removably attached to the U-Shaped head. This removability allows for interchangeability of heads, including, for example with the orbit nipple extractor handle and nipple extractor heads. Preferably the U-Shaped head is made as a directly compatible tool for use with this product or alternately with alternative sprinkler tools.

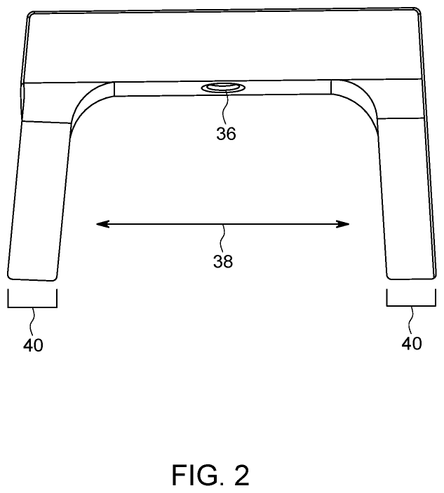

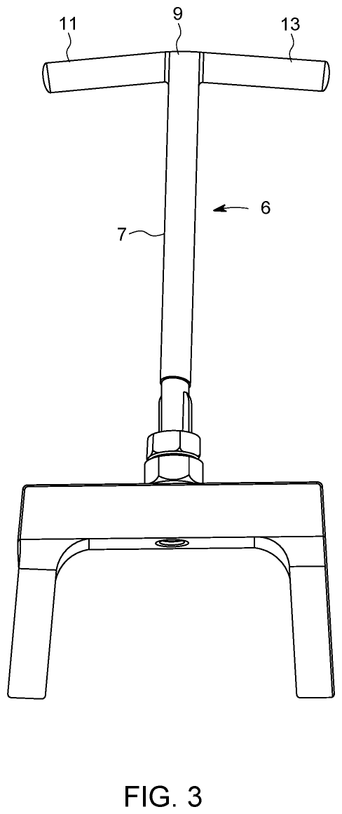

FIG. 1 further illustrates the U-Shaped head having a female opening threadingly engaged with the male threads of the elongate shaft of the elongate handle. FIGS. 2 and 3 illustrate the threaded opening 36 with the elongate shaft detached. In the depicted embodiment the U-shaped head is formed of a continuous or single piece of metal, although the device can be made utilizing multiple components. Alternatively the device can be made expandable in width.

FIG. 2 illustrates a front view of the U-Shaped head of the sprinkler head removal tool. The U-Shaped tool head has a distance or width 38 between the arms or prongs of the U-Shape that is specifically configured to across the retracted riser portion of the sprinkler head so as to be position able into opposing depressions in the cap as shown in FIG. 1. Preferably this width is 2″ up to and including 2½″ The width 40 of each of the prongs is specifically configured for engagement in the depressions of the sprinkler cap, with the width preferably being ⅓″.

FIG. 3 illustrates a front view of the assembled sprinkler head removal tool having an elongate handle and U-shaped head. The elongate handle 6 has shaft 7 and opposing handles 11, 13 extending from the top 9 of the elongate shaft. The handles are positioned and configured such that a user can rotate the handles, causing the U-shaped head to rotate, thus rotating the head of the gear drive sprinkler.

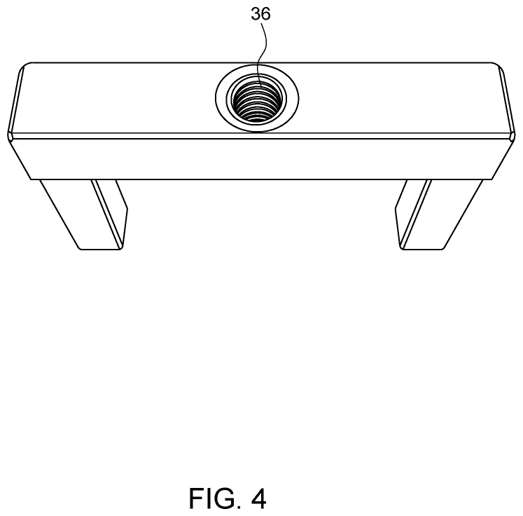

FIG. 4 illustrates a top perspective view of the U-shaped head showing the connection point of the U-shaped head to the shaft of the elongate handle.

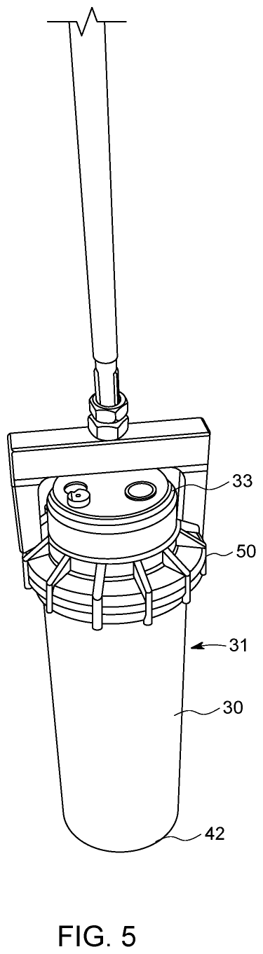

FIG. 5 illustrates the head of the tool engaging an assembled gear drive sprinkler 31. Typically, water flows into the bottom 42 of the housing 30 of the sprinkler. The flow of water into the sprinkler causes the riser 33 to extend away from the housing, and causes the riser to rotate. The sprinkler is positioned in the ground such that soil or dirt extends typically to the top of the sprinkler or higher. The cap 50 is provided with a series of depressions with the opposing arms of the U-shaped tool head engaging the depressions. Rotation of the tool causes rotation of the cap, providing for access to the inner workings of the gear driven sprinkler.

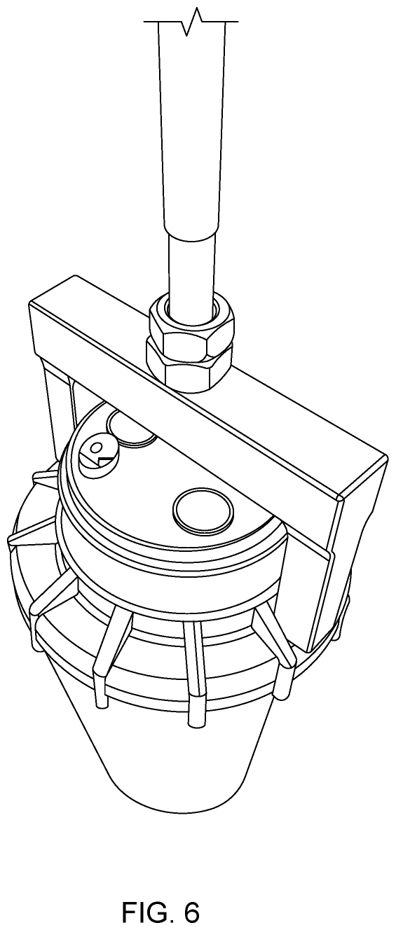

FIG. 6 illustrates a perspective view of the engagement of the arms of the U-shaped head engaged in opposing depressions of the gear drive sprinkler cap. In practice, the soil and grass immediately around the riser are removed if necessary, allowing for access to the depressions.

Still other features and advantages of the presently disclosed and claimed inventive concept(s) will become readily apparent to those skilled in this art from the following detailed description describing preferred embodiments of the inventive concept(s), simply by way of illustration of the embodiments contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

What is claimed is:

1. A sprinkler removal tool comprising:
an elongate handle comprising an elongate shaft; and
a U-Shaped head attached to the elongate handle, the U-Shaped head comprising two opposing prongs extending in a direction generally parallel to the handle, wherein the U-shaped head comprises a cross support and two arms forming the U-shape, wherein said cross support is configured with a width to extend across a center of a gear drive sprinkler cap, wherein said arms are configured to extend beneath said center to engage depressions in said cap, wherein rotation of said handle causes rotation of said cap relative to the body of the gear drive sprinkler.

2. The sprinkler removal tool of claim 1 wherein said U-shaped head is removable from said elongate handle.

3. The sprinkler removal tool of claim 2 wherein said sprinkler removal tool comprises a plurality of interchangeable U-shaped heads, wherein each of said U-shaped heads comprises a cross support of a different length for adjustment of gear drive sprinklers of different sizes.

4. The sprinkler removal tool of claim 1 wherein said U-shaped head is attached to said handle by threaded attachment.

5. The sprinkler removal tool of claim 1 wherein said sprinkler removal tool comprises at least one interchangeable head being a pipe nipple extractor.

6. The sprinkler removal tool of claim 1 wherein said elongate handle is threadingly attached to said U-shaped head.

7. The sprinkler removal tool of claim 1 wherein said handle comprises two opposing hand grips extending in opposite directions from said elongate shaft.

8. The sprinkler removal tool of claim 1 wherein said elongate shaft has a lengthwise axis parallel to the lengthwise axis of each of said arms of said U-shaped head.

9. The sprinkler removal tool of claim 1 wherein said U-shaped head comprises a continuous piece of metal.

10. The sprinkler removal tool of claim 1 wherein said U-shaped head comprises aluminum.

11. The sprinkler removal tool of claim 1 wherein said U-shaped head is fixedly attached to said handle.

12. The sprinkler removal tool of claim 1 wherein said handle comprises a T-shape.

13. The sprinkler removal tool of claim 1 wherein said handle comprises a rubber coating.

14. The sprinkler removal tool of claim 1 wherein said handle comprises a plastic coating.

15. The sprinkler removal tool of claim 1 wherein said arms of said U-shape are parallel to said elongate shaft of said handle.
